(19) United States
(12) Patent Application Publication
(10) Pub. No.: US 2008/0239603 A1
(43) Pub. Date: Oct. 2, 2008

(54) BATTERY PROTECTION CIRCUIT FOR LITHIUM CABON MONOFLUORIDE BATTERY

(75) Inventors: Gregg C. Bruce, Vancouver (CA); Maurice Brule, Surrey (CA); Nicholas R. Massey, North Vancouver (CA)

Correspondence Address: SNELL & WILMER L.L.P. (Main), 400 EAST VAN BUREN, ONE ARIZONA CENTER, PHOENIX, AZ, 85004-2202, US

(73) Assignee: EAGLEPICHER ENERGY PRODUCTS CORPORATION, Surrey (CA)

(21) Appl. No.: 12/057,035

(22) Filed: Mar. 27, 2008

Related U.S. Application Data
(60) Provisional application No. 60/908,354, filed on Mar. 27, 2007.

(51) Int. Cl. H02H 7/18; H02J 7/00

(52) U.S. Cl. 361/84; 320/116

(57) ABSTRACT

A protection circuit for a primary battery pack provides the battery pack with reverse charge protection. The protection circuit features a metal oxide semiconductor field effect transistor (MOSFET) with a steady state source to drain voltage. The source to drain voltage is controlled through a feedback loop that includes an operational amplifier. The MOSFET is configured in series with one or more battery cells allowing current to flow from the cells and preventing current from flowing to the cells. The MOSFET provides reverse charge protection with a small forward voltage drop and a small reverse charge leakage current.

### CROSS-REFERENCE TO RELATED APPLICATIONS

This application claims priority to and the benefit of U.S. Provisional Application Ser. No. 60/908,354, filed on Mar. 27, 2007, and entitled BATTERY PROTECTION CIRCUIT FOR LITHIUM CARBON MONOFLUORIDE BATTERY.

### FIELD OF INVENTION

The present invention relates to battery protection circuits. More particularly, the invention relates to battery protection circuits for battery packs featuring lithium carbon monofluoride (Li—CFx) battery cells.

### BACKGROUND OF THE INVENTION

Battery packs provide electrical power for electrical loads. Primary battery packs feature battery cells that deliver power to electrical loads by irreversibly converting potential chemical energy into electrical energy. Secondary battery packs feature battery cells that reversibly convert chemical energy into electrical energy and may be “recharged” converting electrical energy back into potential chemical energy. Battery packs having one or more Li—CFx battery cells are not rechargeable and thus are primary battery packs.

Li—CFx cells have high energy density, a long shelf life and are light in weight. This makes battery packs featuring Li—CFx cells ideal for many applications, including military applications. Primary battery packs with Li—CFx cells are often packaged to look and feel like the secondary battery packs used to drive the same or similar electrical loads. The similar packaging presents a concern that a battery pack with Li—CFx cells will be improperly placed into a secondary battery pack charger leading to cell leakage or an explosion.

To protect the cells of a primary battery pack from receiving an inadvertent and potentially dangerous charge, a Schottky diode may be introduced. The Schottky diode is placed in series with cells and oriented to allow current (charge) to flow from the cells and prevent current from flowing to the cells. The Schottky diode, however, introduces an undesirable forward voltage drop of about 0.15 to 0.45 Volts. The forward voltage drop for Schottky diodes having desirable small reverse voltage leakage currents is especially high (often greater than 0.35 volts). This high Schottky diode forward voltage drop results in less cell voltage being delivered to the electrical load.

The use of a Schottky diode is especially problematic for Li—CFx battery packs, particularly when used in harsh environments. Li—CFx battery packs may feature two cells of about 3.0 volts arranged in series to provide a 6.0 volt battery pack. The small number of cells (i.e., two) and the large cathode voltage delays characteristic of Li—CFx cells make it difficult to introduce a Schottky diode and meet many low-temperature operating requirements, such as MIL-PRF-49471B.

Those skilled in the art will appreciate that there is a need for a protective circuit for primary battery packs that does not introduce a large forward voltage drop or introduce a large voltage delay.

### SUMMARY OF THE INVENTION

A reverse charge protection circuit features a metal oxide semiconductor field effect transistor (MOSFET). The MOSFET is configured to be connected in series with one or more battery cells of a primary battery pack. The MOSFET is biased through a feedback control loop having a control element. The control element drives the MOSFET source to drain voltage to a predetermined constant voltage by controlling the MOSFET gate voltage. The MOSFET operates principally in the ohmic region conducting current away from the battery cells and preventing current from flowing to the battery cells.

### BRIEF DESCRIPTION OF THE DRAWING FIGURES

A more complete understanding of the present invention may be derived by referring to the detailed description and claims when considered in connection with the drawing figures, where like reference numbers refer to similar elements throughout the figures, and:

FIG. 1 is a diagram of an exemplary embodiment of a primary battery pack according to an embodiment of the present invention;

FIG. 2 is a diagram of an exemplary embodiment of a battery protection circuit for battery cells of a primary battery pack featuring an N-channel MOSFET; and

FIG. 3 is a diagram of an exemplary embodiment of a battery protection circuit for battery cells of a primary battery pack featuring a P-channel MOSFET.

### DETAILED DESCRIPTION

The following description is of exemplary embodiments of the invention only, and is not intended to limit the scope, applicability, or configuration of the invention in any way. Rather, the following description is intended to provide a convenient illustration for implementing various exemplary embodiments of the invention. As will become apparent, various changes may be made in the function and arrangement of the elements described in these embodiments without departing from the scope of the invention as set forth in the appended claims.

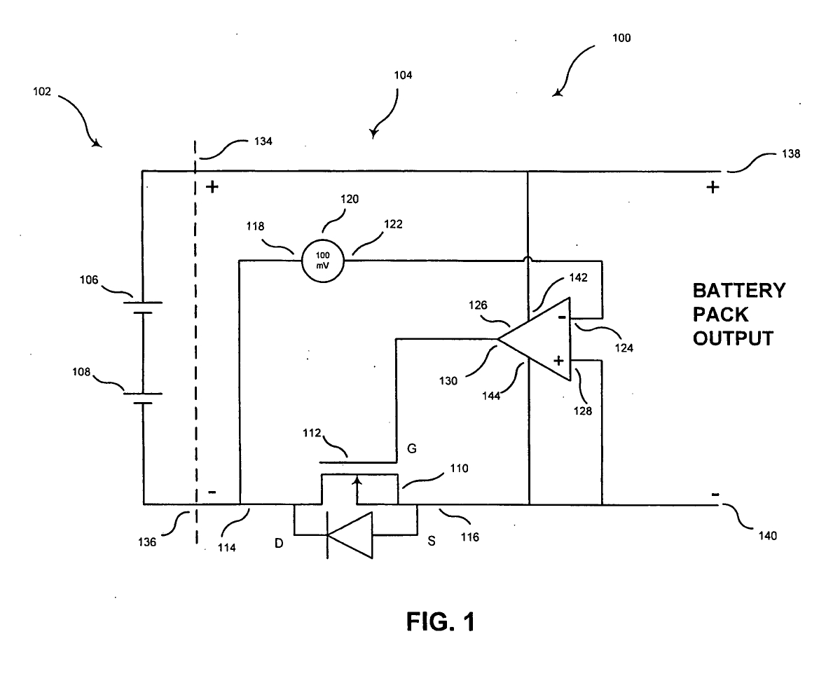

FIG. 1 illustrates a battery pack 100 according to an exemplary embodiment of the present invention. The battery pack 100 comprises battery cells 102 electrically connected with a circuit 104.

The battery cells 102 comprise a first cell 106 and second cell 108 connected in series.

The circuit 104 comprises a MOSFET 110 having a gate 112, a drain 114 and a source 116. The drain 114 is connected with a negative terminal 118 of a power supply 120. The power supply 120 has a positive terminal 122 that is connected with the inverting input 124 of an operational amplifier 126. The operational amplifier 126 has a non-inverting input 128 connected with the source 116 of the MOSFET 110 and an output 130 connected with the gate 112 of the MOSFET 110.

The circuit 104 has a positive input 134 connected with the first cell 106 and a negative input 136 connected with the second cell 108. The positive input 134 is also connected with a positive power input 142 of the operational amplifier 126. The circuit 104 also has a positive output 138 electrically equivalent to the positive input 134, and a negative output 140. The negative output 140 is connected with the negative power input 144 of the operational amplifier 126.

The circuit 104 is configured to prevent current from flowing to the battery cells 102 from the outputs 138, 140. The MOSFET 110 performing the current gate-keeping function is an n-channel MOSFET configured with source 116 and drain 114 in communication with the battery cells 102. The circuit 104 also features a control loop configured to provide a small source 116 to drain 114 voltage and a thus a small overall circuit 104 voltage drop between inputs 134, 136 and outputs 138, 140. The circuit 104 is configured to function in four primary states: namely load attached, no load attached, charger connection, and forced discharge.

In this embodiment of the battery pack 100 the battery cells 102 are comprised of two lithium carbon monofluoride (Li—CFx) battery cells 106, 108. Alternate embodiments feature lithium manganese dioxide (Li—MnO₂) battery cells as well as other types of non-rechargeable battery cells. Alternate embodiments may also feature one or more battery cells 102. The battery cells 102 may be configured in series, in parallel, or in a series and parallel topology.

The circuit 104 operates in a quiescent state when outputs 138, 140 are open (i.e. no load is applied). In the quiescent state, the power supply 120 voltage determines the source 116 to drain 114 voltage of the MOSFET 110. The MOSFET 110 is configured to operate in the ohmic region with the MOSFET 110 conducting the op-amp 126 quiescent supply current from the source 116 to the drain 114. The MOSFET 110 source 116 to drain 114 voltage is controlled through a feedback loop.

In this embodiment, the circuit 104 features an n-channel MOSFET 110. In an exemplary embodiment, the MOSFET 110 is an International Rectifier IRF7470. Alternate embodiments feature bipolar junction transistors, p-channel MOSFETS as well as other types of transistors as would be known to one skilled in the art.

The feedback loop is configured to operate with the power supply 120 supplying a reference voltage to the inverting input 124 of the operational amplifier 126. In one embodiment, the reference voltage supplied is 100 mV greater than the MOSFET 110 drain 114 voltage. In another embodiment, the reference voltage supplied is from about 10 mV to about 200 mV volts greater than the MOSFET 110 drain 114 voltage. In addition, the reference voltage may be any voltage suitable to operate the MOSFET 110 in an ohmic state. The lower range of the reference voltage is dependent on the accuracy of the circuit 104; a more accurate the circuit can be operated with a lower reference voltage. The non-inverting input 128 of the operational amplifier 126 is fed with the source 116 voltage of the MOSFET 110.

In this embodiment the operational amplifier 126 is featured as a control element in the feedback control loop. Other embodiments feature other types of control elements, such as transistor circuits, microprocessors or the like. Moreover, any suitable control element as would be known to one skilled in art may be used.

The operational amplifier 126 is configured to be powered by the battery cells 102. The operational amplifier 126 compares the source 116 voltage with the reference voltage and outputs a control voltage. The control voltage of the operational amplifier 126 drives the gate 112 of the MOSFET 110 completing the feedback loop.

In this embodiment the operational amplifier 126 and the MOSFET 110 are powered by the battery cells 102. Alternate embodiments may feature an independent power source. In one embodiment, the operational amplifier 126 and the MOSFET 110 are both powered by an independent power source. In another embodiment, the operational amplifier 126 and the MOSFET 110 are powered by separate independent power sources.

The feedback loop is configured to control the source 116 to drain 114 voltage of the MOSFET 110 in normal operation by driving the source 116 to drain 114 voltage to the power supply 120 voltage. The open circuit output 138, 140 voltage of the circuit is thus less than the battery cells 102 voltage by the voltage amount of the power supply. In one embodiment, the power supply 120 voltage is 100 mV, resulting in the open circuit output 138, 140 voltage of the circuit being 100 mV less than the battery cells 102 voltage.

When a load is properly applied between the outputs 138, 140 of the circuit 104, the feedback loop insures that the source 116 to drain 114 voltage of the MOSFET 110 remains 100 mV. The MOSFET 110 operates in an ohmic region conducting current from source 116 to drain 114. Current flows from the battery cells 102 through the load (not shown), through the MOSFET 110 and back to the battery cells 102.

When the battery pack 100 is improperly placed in a battery charger (not shown), current will begin to flow from the circuit outputs 138, 140 toward the circuit inputs 134, 136 and toward the battery cells 102. This will force the MOSFET 110 source 116 to drain 114 voltage to drop below the power supply 120 voltage with the operational amplifier 126 increasing the source 116 to drain 114 resistance until the MOSFET 110 is turned off. With the MOSFET 110 turned off, the MOSFET 110 will not conduct current, creating an open circuit 104 between the battery cells 102 and the battery charger and protecting the battery cells 102 from a charging current.

When the battery pack 100 undergoes a forced discharge, the control loop will maintain a 100 mV source 116 to drain 114 voltage with the battery cells 102 discharging through the circuit 104. When the battery cells 102 no longer have enough power to power the MOSFET 110, forced current will flow through the MOSFET body diode.

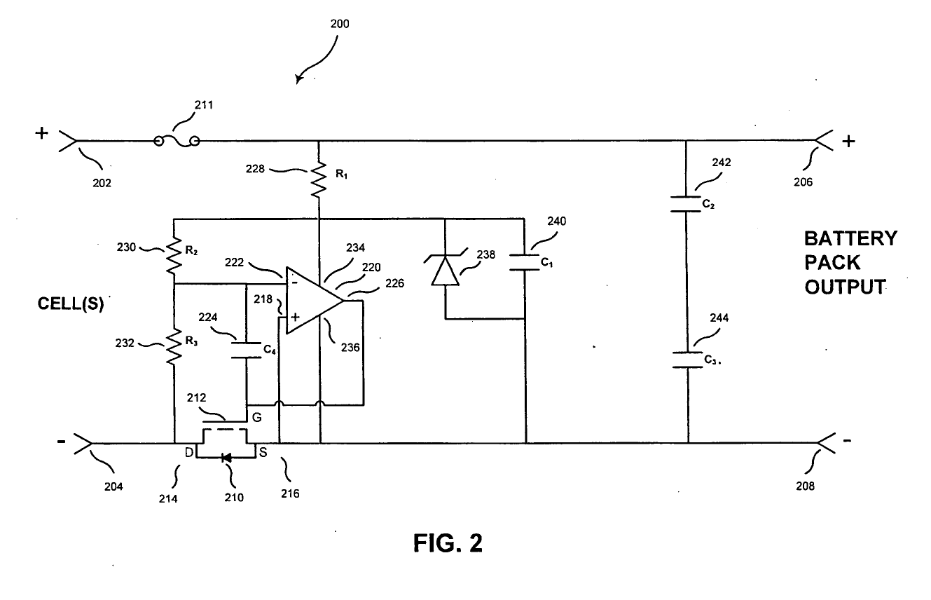

FIG. 2 illustrates a battery cell protection circuit 200 featuring an N-Channel MOSFET according to an embodiment of the present invention. The battery cell protection circuit 200 has a positive input 202 and a negative input 204. The battery cell protection circuit 200 also has a positive output 206 and a negative output 208. The positive input 202 is connected with the positive output 206 through a fuse 211.

A MOSFET 210 having a gate 212, a drain 214 and a source 216 is configured with the source 216 connected to the negative output 208 of the battery protection circuit 200 and the drain 214 connected with the negative input 204 of the battery protection circuit 200. The source 216 is also connected with a non-inverting input 218 of an operational amplifier 220. The gate 212 is connected with the inverting input 222 of the operational amplifier 220 through capacitor C₄ 224. The output of the operational amplifier 226 is connected with the gate 212.

A voltage divider comprised of resistors R₁ 228, R₂ 230, and R₃ 232 is configured in series and extends from the fuse 211 to the negative input 204 of the battery cell protection circuit 200. The voltage divider is connected with the inverting input 222 of the operational amplifier 220 between resistors R₂ 230 and R₃ 232.

The operational amplifier 220 is configured with a positive power input 234 connected with the voltage divider between resistors R₁ 228 and R₂ 230. The operational amplifier 220 also has a negative power input 236 connected with the source 216 of the MOSFET 210. A Zener diode 238 and capacitor C₁ 240 are configured in parallel with the positive power input 234 and negative power input 236 of the operational amplifier 220.

Capacitors, C₂ 242 and C₃ 243 are configured in series and extend from the positive power output 206 to the negative power output 208 of the battery cell protection circuit 200. Capacitors C₂ 242 and C₃ 244 provide the battery cell protection circuit with electrostatic discharge protection.

The battery cell protection circuit 200 is configured to protect primary battery cells from a charging current. The MOSFET 210 conducts current from the source 216 to drain 214 when a load is connected to the outputs 206, 208 of the battery protection circuit 200. In addition, the MOSFET 210 is also configured to turn off when outputs 206, 208 are connected to a charger. When the battery cell protection circuit 200 is improperly placed in a battery charger (not shown), current will begin to flow from the circuit outputs 206, 208 toward the circuit inputs 202, 204 and toward the battery cells. This will force the MOSFET 210 source 216 to drain 214 voltage to drop and the operational amplifier 220 to increase the source 216 to drain 214 resistance until the MOSFET 210 is turned off. With the MOSFET 210 turned off, the MOSFET 210 will not conduct current, creating an open circuit between the battery cells and the battery charger and protecting the battery cells from a charging current.

In this embodiment, the battery cell protection circuit 200 features an n-channel MOSFET 210. Alternate embodiments may feature bipolar junction transistors, p-channel MOSFETS as well as other types of transistors as would be known to one skilled in the art.

The voltage divider comprising the cell voltage of battery cells (Cellvoltage) and resistors R₁, R₂ and R₃ determines the source 216 to drain 214 voltage of the MOSFET 210. The voltage divider provides

$$\frac{( Cellvoltage ) ( {R}_{3} )}{{R}_{1} + {R}_{2} + {R}_{3}}$$

volts to the inverting input 222 of the operational amplifier 220. In this exemplary embodiment, resistor R₁ is 47 KΩ, resistor R₂ is 10 MΩ and resistor R₃ is 100 KΩ. Thus 0.03 volts (30 mV) are provided to the inverting input 222 of the operational amplifier 220 when a 3 volt cell drives inputs 202, 204.

The non-inverting input 218 of the operational amplifier 220 is fed with the source 216 voltage of the MOSFET 210. The output 226 of the operational amplifier 220 drives the gate 212 of the MOSFET 210, forming a feedback loop. The operational amplifier 220 compares the source 216 voltage with the voltage at resistor R₃ 232 and provides a control voltage to the gate 212 of the MOSFET 210. The control voltage drives the source 216 to drain 214 voltage of the MOSFET 210 to the approximate voltage drop observed across resistor R₃ 232.

Capacitor C₄ 224 is configured between the output 226 of the operational amplifier and the inverting input 222 of the operational amplifier. Capacitor C₄ provides the feedback loop with stability by dampening the feedback response.

In this embodiment, capacitor C₄ is 27 nF. In alternate embodiments C₄ may be larger or smaller, for example in the range of about 10 nF to about 100 nF. Moreover, capacitor C₄ may be of any capacitance which introduces effective damping of the feedback response. In another embodiment, a battery cell protection circuit 200 may not include capacitor C₄.

Zener diode 238 provides over-voltage protection for the operational amplifier 220. When the Zener diode 238 reaches its breakdown voltage it will maintain the breakdown voltage across the diode and hold the supply voltage of operational amplifier 220 constant, protecting it from an over-voltage. In this embodiment the Zener diode has a breakdown voltage of 12 V. Other embodiments may feature Zener diodes with other breakdown voltages. The breakdown voltage is determined by the maximum allowable supply voltage of operational amplifier 220. For example, the Zener diode may have a breakdown voltage in the range of about 6 volts to about 18 volts. In another embodiment, a battery cell protection circuit 200 may not include a Zener diode for over-voltage protection.

Capacitor C₁ 240 provides the battery cell protection circuit 200 with stability by sourcing operational amplifier 220 power current spikes that would not otherwise flow through resistor R₁. The stability is provided when operational amplifier 220 draws more current than is available through R₁, the additional current is supplied by a charged C₁. In one embodiment, C₁ 240 is larger than C₄ 224 to maintain the circuit stability.

In this embodiment, capacitors C₁, C₂ and C₃ are each 100 nF. In alternate embodiments C₁ C₂ and C₃ may be larger or smaller, for example in the range of about 50 nF to about 1 μF. In another embodiment, a battery cell protection circuit 200 may not include capacitors C₁, C₂, or C₃ or any combinations of C₁, C₂, and/or C₃.

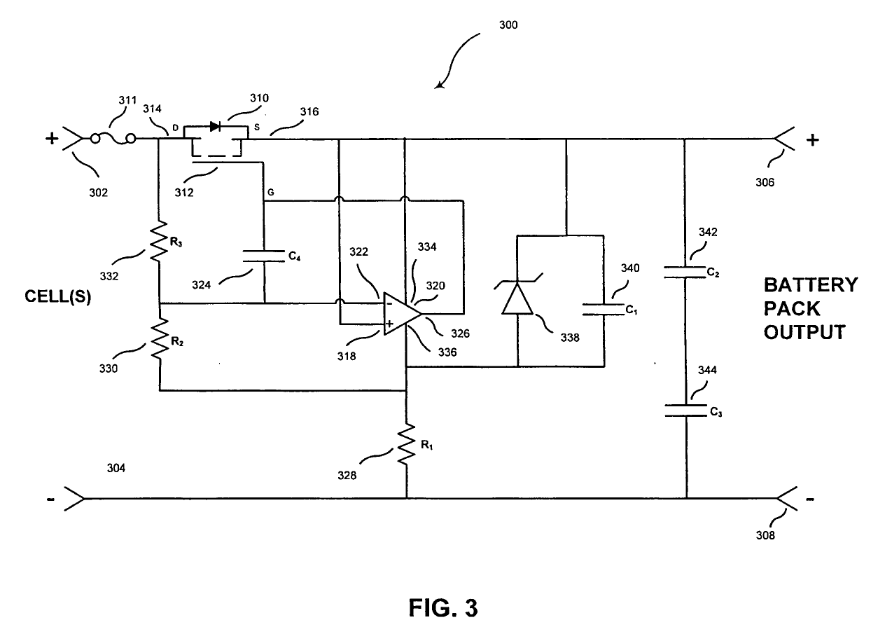

FIG. 3 illustrates a battery cell protection circuit 300 featuring a P-Channel MOSFET according to an embodiment of the present invention. The battery cell protection circuit 300 has a positive input 302 and a negative input 304. The battery cell protection circuit 300 also has a positive output 306 and a negative output 308. The positive input 302 is connected with the positive output 306 through a fuse 311.

A MOSFET 310 having a gate 312, a drain 314 and a source 316 is configured with the source 316 connected to the positive output 306 of the battery protection circuit 300 and the drain 314 connected with the positive input 302 through the fuse 311. The source 316 is also connected with a non-inverting input 318 of an operational amplifier 320. The gate 312 is connected with an inverting input 322 of the operational amplifier 320 through capacitor C₄ 324. The output 326 of the operational amplifier 320 is connected with the gate 312.

A voltage divider comprised of resistors R₁ 328, R₂ 330, and R₃ 332 is configured in series and extends from the fuse 311 to the negative input 304 of the battery cell protection circuit 300. The voltage divider is connected with the inverting input 322 of the operational amplifier 320 between resistors R₂ 330 and R₃ 332.

The operational amplifier 320 is configured with a positive power input 334 connected with the source 316 of the MOSFET 310. The operational amplifier 320 also has a negative power input 336 connected with the voltage divider between resistors R₁ 328 and R₂ 330. A Zener diode 338 and capacitor C₁ 340 are configured in parallel with the positive power input 334 and negative power input 336 of the operational amplifier 320.

Capacitors, C₂ 342 and C₃ 344 are configured in series and extend from the positive power output 306 to the negative power output 308 of the battery cell protection circuit 300.

The battery cell protection circuit 300 is configured to protect primary battery cells from a charging current. The MOSFET 310 conducts current from the drain 314 to the source 316 when no load or a proper load is connected to the outputs 306, 308 of the battery protection circuit 300. The MOSFET 310 is also configured to turn off when outputs 306, 308 are connected to a charger. A charger at output 306, 308 creates a positive source 316 to drain 314 voltage which causes the op-amp to turn off the MOSFET 310.

In this embodiment, the battery cell protection circuit 300 features a p-channel MOSFET 310. Alternate embodiments may feature bipolar junction transistors, n-channel MOSFETS as well as other types of transistors as would be known to one skilled in the art.

The voltage divider comprising the cell voltage of the battery cells (Cellvoltage) and resistors R₁, R₂ and R₃ determines the drain 314 to source 316 voltage of the MOSFET 310. The voltage divider provides

$$Cellvoltage - \frac{( Cellvoltage ) ( {R}_{3} )}{{R}_{1} + {R}_{2} + {R}_{3}}$$

volts to the inverting input 322 of the operational amplifier 320. In this exemplary embodiment, resistor R₁ is 47 KΩ, resistor R2 is 10 MΩ and resistor R3 is 100 KΩ. Thus, in accordance with an exemplary embodiment, (Cellvoltage −0.06) volts are provided to the inverting input 322 of the operational amplifier 320 when two 3 volt cells in series drive inputs 302, 304.

The non-inverting input 318 of the operational amplifier 320 is fed with the source 316 voltage of the MOSFET 310. The output 326 of the operational amplifier 320 drives the gate 312 of the MOSFET 310 forming a feedback loop. The operational amplifier 320 compares the source 316 voltage with resistor R₃ 332 voltage divider voltage and provides a control voltage to the gate 312 of the MOSFET 310. The control voltage drives the drain 314 to source 316 voltage of the MOSFET 310 to the voltage drop observed across resistor R₃ 332.

Capacitor C₄ 324 is configured between the output 326 of the operational amplifier and the non-inverting input 322 of the operational amplifier. Capacitor C₄ provides the feedback loop with stability by dampening the feedback response.

In accordance with one exemplary embodiment, capacitor C₄ is 27 nF. In alternate embodiments C₄ may be larger or smaller, for example in the range of about 10 nF to about 100 nF. Moreover, capacitor C₄ may be of any capacitance which introduces effective damping of the feedback response. In accordance with another exemplary embodiment, a battery cell protection circuit 300 may not include capacitor C₄.

Zener diode 338 provides over-voltage protection for the operational amplifier 320. When the Zener diode 338 reaches its breakdown voltage it will maintain the breakdown voltage across the diode and hold the supply voltage of operational amplifier 320 constant, protecting it from an over-voltage. In this embodiment the Zener diode has a breakdown voltage of 12 V. Other embodiments may feature Zener diodes with other breakdown voltages. The breakdown voltage is determined by the maximum allowable supply voltage of operational amplifier 320. For example, in accordance with one exemplary embodiment, a Zener diode may have a breakdown voltage in the range of about 6 volts to about 18 volts. In accordance with another exemplary embodiment, a battery cell protection circuit 300 may not include a Zener diode for over-voltage protection.

Capacitor C₁ 340 provides the battery cell protection circuit 300 with stability by sourcing operational amplifier 320 power current spikes that would not otherwise flow through resistor R₁ 328. The stability is provided when operational amplifier 320 draws more current than is available through R₁ 328, the additional current is supplied by a charged C₁ 340. In one embodiment, C₁ 340 is larger than C₄ 324 to maintain the circuit stability.

Capacitors C₂ 342 and C₃ 344 are configured in series and extend from positive output 306 to negative output 308. Capacitors C₂ 342 and C₃ 344 provide the battery cell protection circuit with electrostatic discharge protection.

In accordance with one exemplary embodiment, capacitors C₁, C₂ and C₃ are 100 nF. In other exemplary embodiments C₁ C₂ and C₃ may be larger or smaller, for example in the ranges of for example in the range of about 50 nF to about 1 μF. In accordance with still another exemplary embodiment, a battery cell protection circuit 300 may not include capacitors C₁, C₂, or C₃ or any combinations of C₁, C₂, and/or C₃.

In accordance with various embodiments of the instant invention, battery protection circuits using a FET have a low voltage drop, allowing more battery cell voltage to be delivered to a load and the load circuit to have a higher voltage. This higher voltage increases the power output of the battery, resulting in better low temperature operation and less voltage delay when compared to general battery protection circuits using a diode. Additionally, the voltage drop across the FET is more consistent over a temperature range than the voltage drop across a diode.

Those skilled in the art will recognize there are many equivalent circuits to those disclosed with alternate circuit topologies, circuit elements, and element sizes and functions. The scope of the disclosed invention is not limited to the exemplary embodiments described but embraces all embodiments and equivalents recited in the claims.

Finally, it should be understood that various principles of the invention have been described in illustrative embodiments only, and that many combinations and modifications of the above-described structures, arrangements, proportions, elements, materials and components, used in the practice of the invention, in addition to those not specifically described, may be varied and particularly adapted to specific users and their requirements without departing from those principles.

1. A protection circuit for a battery cell, comprising:
a field effect transistor having a drain and a source connected in series with the battery cell; and
a circuit for maintaining a constant voltage between the source and the drain.

2. The protection circuit of claim 1 wherein the field effect transistor is an N channel MOSFET.

3. The protection circuit of claim 1 wherein the field effect transistor is a P channel MOSFET.

4. The protection circuit of claim 1 wherein the constant voltage is between about 10 and about 200 millivolts.

5. The protection circuit of claim 1 wherein the battery cell is a lithium carbon monofluoride cell.

6. The protection circuit of claim 1 wherein the circuit includes an operational amplifier for driving the field effect transistor.

7. The protection circuit of claim 1 wherein the operational amplifier is powered by the battery cell.

8. A battery pack comprising:
two or more lithium carbon monofluoride battery cells connected in series; and
a reverse charge protection circuit comprising
a field effect transistor electrically connected in series with said two or more lithium carbon monofluoride battery cells, and
a biasing circuit for biasing the field effect transistor to conduct current away from said two or more lithium carbon monofluoride battery cells and preventing current from flowing toward said two or more lithium carbon monofluoride battery cells.

9. The battery pack of claim 8 wherein the bias circuit includes an operational amplifier for controlling a source to drain voltage of the field effect transistor.

10. The battery pack of claim 9 wherein the field effect transistor has a gate and the operational amplifier has an output electrically connected with the gate.

11. The battery pack of claim 10 wherein the operational amplifier has a first input for receiving an input voltage that determines the source to drain voltage of the field effect transistor.

12. The battery pack of claim 11 wherein the operational amplifier has a second input for receiving a feedback voltage.

13. The battery pack of claim 12 wherein the source to drain voltage is less than about 200 millivolts.

14. The battery pack of claim 12 wherein the field effect transistor is an International Rectifier IRF7470 field effect transistor.

15. A battery pack comprising:
two lithium carbon monofluoride battery cells connected in series;
a field effect transistor having a gate, a drain and a source connected in series with said two lithium carbon monofluoride battery cells; and
an operational amplifier powered by the two lithium carbon monofluoride battery cells having a first input electrically connected with the drain, a second input electrically connected with the source and an output electrically connected with the gate.

16. The battery pack of claim 15 wherein the field effect transistor is a MOSFET.

17. The battery pack of claim 15 further comprising a Zener diode in parallel with the power inputs of the operational amplifier to protect the operational amplifier from an over voltage.

18. The battery pack of claim 15 further comprising a voltage divider for providing an input voltage to the operational amplifier.

19. The battery pack of claim 15 wherein a quiescent drain to source current is less than 2 microamps.
